(19) United States
(12) Patent Application Publication
(10) Pub. No.: US 2010/0313385 A1
(43) Pub. Date: Dec. 16, 2010

(54) Protective handle cover

(76) Inventors: Richard W. Brahler, II, Jacksonville, IL (US); Jeff Alexander, Jacksonville, IL (US)

Correspondence Address: Law Offices of Mark E. Wiemelt, P.C., Ste. 3300, 10 S. LaSalle St., Chicago, IL, 60603, US

(21) Appl. No.: 12/456,026

(22) Filed: Jun. 10, 2009

(51) Int. Cl. B25G 1/10

(52) U.S. Cl. 16/421

(57) ABSTRACT

A protective handle cover for installation on an end of a handle. The protective handle cover protects a finished surface from damage when a handle with the protective handle cover installed falls against the finished surface. The protective handle cover also facilitates gripping of the handle. The protective handle cover is particularly suited for vehicle jacks, tire-changing tools and long-handled tools, but may be also used advantageously on many other handles.

### CROSS-REFERENCE TO RELATED APPLICATIONS

There are no related applications for this application.

### FIELD OF THE INVENTION

This invention is directed toward the field of handles, such as vehicle jack or tool handles and handle covers. The invention is further directed toward improvements to existing handle covers to prevent handles with existing covers, as well as handles without covers from damaging surfaces they may inadvertently come in contact with.

### BACKGROUND OF THE INVENTION

Handles, such as vehicle jack handles, tire-changing tool handles, or tool handles are often placed in close proximity to surfaces in which damage is undesirable, such as vehicle bodies, or floors, or walls of buildings. Jack handles, tire-changing tool handles, or tool handles are often made of metal which can easily damage surfaces in which damage is undesirable. Placement of the jack handles, tire-changing tool handles, or tool handles in close proximity to vehicles, floors, or walls may result in the handles inadvertently falling against a finished surface, such as a portion of a vehicle body, a floor, or a wall. The handles falling and impacting against a finished surface causes scratches, dents, or other damage to the finished surface. This is particularly a problem when a long pivotally attached handle, such as is often found on a jack, tire-changing tool, or garden tool, inadvertently falls against an adjacent vehicle and damages the finished surface of the vehicle. Long handled tools, such as a shovel can also fall against a floor, or wall, causing damage to the floor, or wall.

A cover for the end of a handle could reduce, or even eliminate potential damage to a finished surface caused by the handle inadvertently falling against the finished surface. Handle covers may also facilitate gripping the handle. Jacks, tire-changing tools, or garden tools are often manufactured without any handle covers which might prevent, or lessen such damage. When such handle covers exist, they are generally tight fitting covers which offer limited protection from causing damage to a finished surface when the handle falls and impacts against a finished surface. These tight fitting existing handle covers still have the potential to damage a finished surface when the handle falls against the finished surface.

What is needed is a handle cover that would offer increased protection against damage to a finished surface when a handle falls and impacts against a finished surface. Such a protective handle cover would satisfy the need to eliminate any damage to a finished surface caused by a handle impacting against the finished surface. The protective handle cover will also facilitate gripping of the handle.

### SUMMARY OF THE INVENTION

The invention is directed toward a protective handle cover. The protective handle cover is particularly suited for vehicle jacks, tire-changing tools and long-handled tools, but may be also used advantageously on many other handles. The protective handle cover is installed on an end of a handle. The protective handle cover is formed of a resilient material. The design of the protective handle cover includes an inner portion and an outer portion. The inner portion of the protective handle cover fits over an end of a handle. The outer portion of the protective handle cover extends beyond the end of the handle and terminates in a generally bulbous head. The outer portion of the protective handle cover is also formed such that an empty volume exists within the upper portion. This empty volume contains air which is trapped in the empty volume when the protective handle cover is installed. The design of the protective handle cover reduces damage to a finished surface when a handle falls and impacts against a finished surface. The design of the protective handle cover also facilitates gripping of the handle.

There has been outlined, rather broadly, the more important features of the invention in order that the detailed description thereof that follows may be better understood, and in order that the present contribution to the art may be better appreciated. There are, of course, additional features of the invention that will be described hereinafter and that will form the subject matter of the invention.

As such, those skilled in the art will appreciate that the conception, upon which this disclosure is based, may readily be utilized as a basis for designing of other structures, methods, and systems for carrying out the several purposes of the present invention. It is important, therefore, that the claims be regarded as including such equivalent constructions in so far as they do not depart from the spirit and scope of the present invention.

For a non-limiting example, it is readily apparent that the inventive device could be made in such a way that the first working and second working end are manufactured on separate lever arms.

Further, the purpose of the abstract is to enable the US patent and trademark office and the public generally, and especially the scientists, engineers and practitioners in the art who are not familiar with the patent or legal terms or phraseology, to determine quickly from what cursory inspection the nature and essence of the technical disclosure of the application. The abstract is neither intended to define the invention of the application, which is measured by the claims, nor is it intended to be limiting as to the scope of the present invention in any way.

These together with other objects of the present invention, along with the various features of novelty which characterize the present invention, are pointed out with particularity in the claims annexed to and forming a part of this disclosure. For a better understanding of the present invention, its operating advantages and the specific objects attained by its uses, reference should be had to the accompanying drawings and descriptive matter in which there is illustrated a preferred embodiment of the present invention.

### BRIEF DESCRIPTION OF THE DRAWINGS

The detailed description particularly refers to the accompanying figures in which:

FIG. 1 is a top view of the protective handle cover.

FIG. 2 is a cross-sectional view of the protective handle cover.

FIG. 3 illustrates the handle with the protective cover installed after impacting a finished surface.

FIG. 4 illustrates the protective handle cover installed on a pivoting handle of a jack.

FIG. 5 illustrates the protective handle cover installed on a pivoting handle of a movable tire-changing tool.

FIG. 6 illustrates the protective handle cover installed on a handle of a tool, such as a shovel.

### DETAILED DESCRIPTION OF THE DRAWINGS

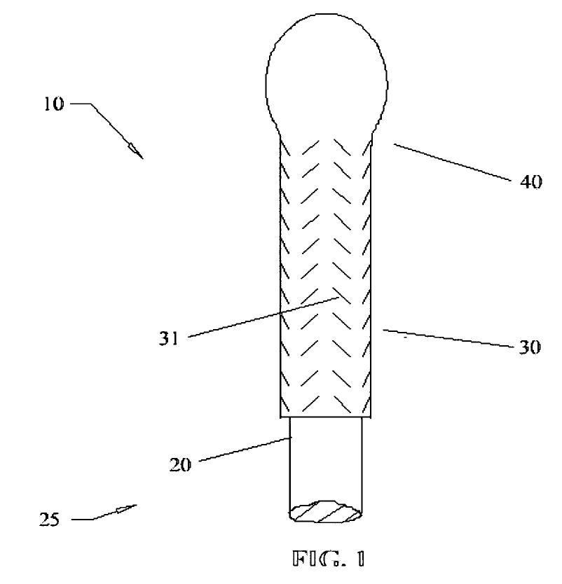

FIG. 1 illustrates a protective handle cover 10. The protective handle cover 10 fits over an end 20 of a handle 25. The protective handle cover contains an inner portion 30 and an outer portion 40. The inner portion 30 fits over the end 20 of the handle 25. The outer portion 40 extends beyond the end 20 of the handle 25. The protective handle cover 10 is formed of a resilient material. An outer surface of the inner portion 30 is formed with gripping indentations 31 to facilitate gripping of the protective handle cover 10.

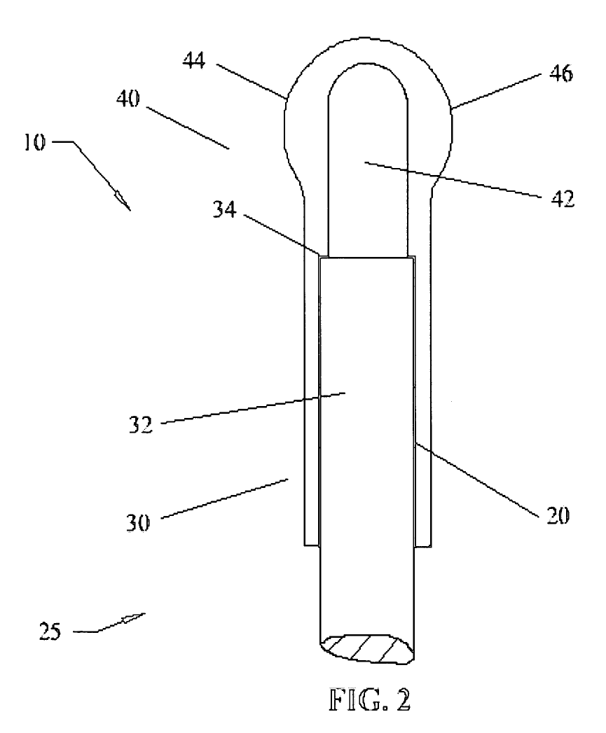

FIG. 2 illustrates a cross-sectional view of the protective handle cover 10 shown in FIG. 1. As illustrated on FIG. 2, the inner portion 30 has an internal recess 32 into which the end 20 of the handle 25 fits. The internal recess 32 of the inner portion 30 ends with a lip 34 which prevents the handle 25 from being inserted further into the protective handle cover 10. The outer portion 40 of the protective handle cover 10 has a second internal recess 42 extending outward from the lip 34 of the inner portion 30 of the handle cover 10. An outer end 44 of the outer portion 40 is formed as a generally bulbous head 46.

The end 20 of the handle 25 is installed into the internal recess 32 of the inner portion 30 of the protective handle cover 10 until the end 20 of the handle 25 seats against lip 34 of the inner portion. When installed, the handle 25 fits snugly with the internal recess 32 of the inner portion 30. The installation of the handle 25 into internal recess 32 also causes ambient air to be trapped in the second internal recess 42.

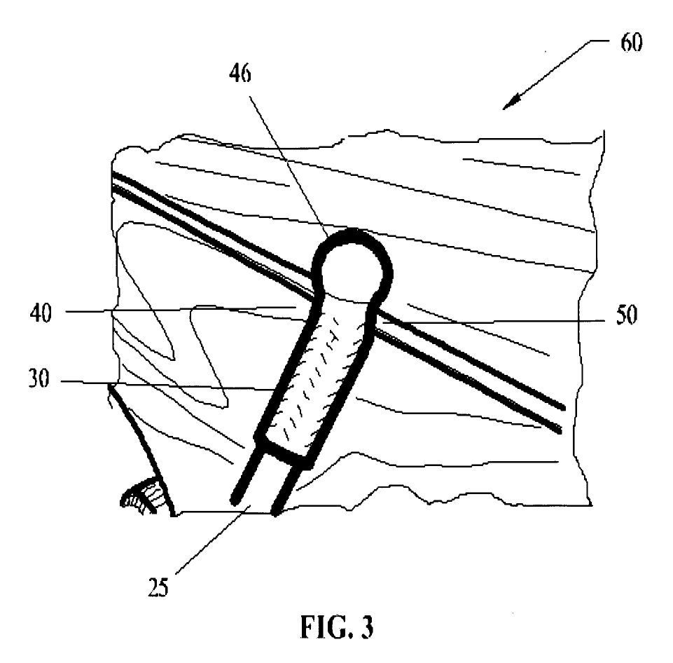

FIG. 3 illustrates the handle 25 after impacting a finished surface 60. As illustrated on FIG. 3, the outer portion 40 of the protective handle cover 10 functions to minimize damage to the finished surface. This is due to the fact that the combination of the resilient material which allows deformation 50 of the outer portion 40 relative to the inner portion 30, the generally bulbous head 46, the ambient air trapped in the second recess 42 (FIG. 2) of the protective handle cover and the fact that the outer portion 40 extends beyond the end 20 of the handle 25 all act together to minimize the effect of the impact of the handle 25 against the finished surface 60. Therefore, damage to the finished surface 60 is minimized when the handle 25 with the protective handle cover 10 installed impacts the finished surface 60.

The protective handle cover 10 may be installed on a variety of components which include handles 25 as follows below.

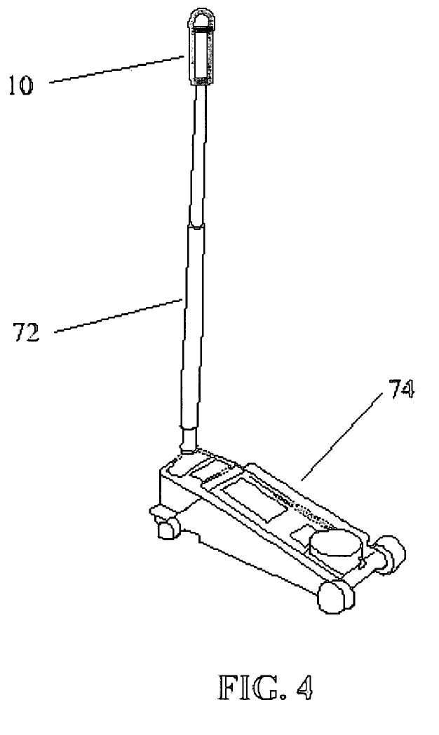

FIG. 4 illustrates the protective handle cover 10 installed on a pivoting handle 72 of a jack 74.

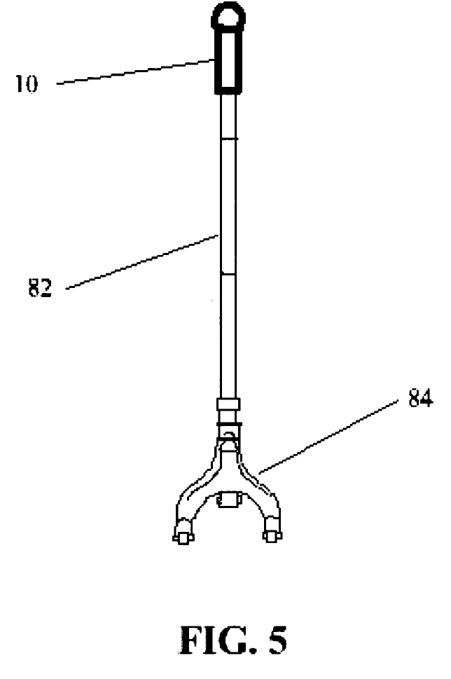

FIG. 5 illustrates the protective handle cover 10 installed on a pivoting handle 82 of a tire-changing tool 84.

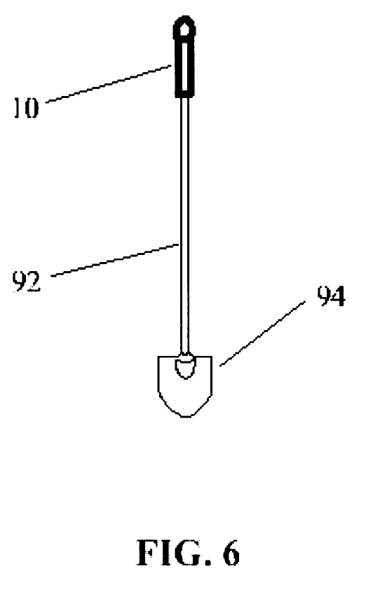

FIG. 6 illustrates the protective handle cover 10 installed on a handle 92 of a tool 94, such as a shovel.

FIGS. 3-6 merely illustrate possible installations for the protective handle cover. The invention is not limited to the installations illustrated on FIGS. 3-6.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced herein.

What is claimed is:

1. A protective handle cover, comprising:
an inner portion,
an outer portion,
wherein an outer end of the outer portion is formed as a bulbous head.

2. The protective handle cover of claim 1, further comprising:
wherein the inner portion is formed with an internal recess that ends at a lip.

3. The protective handle cover of claim 1, further comprising:
wherein the outer portion is formed with a second internal recess.

4. The protective handle cover of claim 1, further comprising:
wherein the inner portion is formed with an internal recess that ends at a lip and wherein the outer portion is formed with a second internal recess.

5. The protective handle cover of claim 4, further comprising:
wherein the second internal recess is smaller in cross-section than the internal recess of the inner portion in cross-section.

6. The protective handle cover of claim 1, further comprising:
wherein the protective handle cover is manufactured of a resilient material.

7. The protective handle cover of claim 1, further comprising:
wherein an outer surface of the inner portion is formed with gripping indentations.

8. A protective handle cover and a handle in combination, comprising:
the handle having an end;
the protective handle cover having an inner portion and an outer portion;
the end of the handle insertable into an internal recess in the inner portion; and
the outer portion extending substantially beyond the end of the handle.

9. The protective handle cover and handle of claim 8, wherein the outer portion has a second internal recess.

10. The protective handle cover and handle of claim 9, wherein the second internal recess contains ambient air which cannot escape when the end of the handle is installed in the internal recess in the inner portion.

11. The protective handle cover and handle of claim 8, wherein an outer end of the outer portion is formed as a bulbous head.

12. The protective handle cover and handle of claim 8, wherein the outer portion is deformable relative to the inner portion when the outer portion is subject to an impact force.

13. The protective handle cover and handle of claim 8, wherein the protective handle cover is manufactured of a resilient material.

14. The protective handle cover and handle of claim 8, wherein an outer surface of the inner portion is formed with gripping indentations.

15. The protective handle cover and handle of claim 8, wherein the handle is the handle of a jack.

16. The protective handle cover and handle of claim 8, wherein the handle is the handle of a tire-changing tool.

17. The protective handle cover and handle of claim 8, wherein the handle is the handle of a tool.

18. The protective handle cover and handle of claim 9, wherein the second internal recess is smaller in cross-section than the internal recess of the inner portion.

19. A protective handle cover and a handle in combination, comprising:
the handle having an end;
the protective handle cover having an inner portion and an outer portion;
the end of the handle insertable into an internal recess in the inner portion;
the outer portion extending substantially beyond the end of the handle;
wherein the outer portion has a second internal recess, and the second internal recess is smaller in cross-section than the internal recess of the inner portion;
wherein the second internal recess contains ambient air which cannot escape when the handle is installed in the internal recess in the inner portion;
wherein an outer end of the outer portion is formed as a bulbous head;
wherein the outer portion is deformable relative to the inner portion when the outer portion is subject to an impact force;
wherein the protective handle cover is manufactured of a resilient material; and
wherein an outer surface of the inner portion is formed with gripping indentations.

20. The protective handle cover and handle of claim 19, wherein the handle is one of the group consisting of the handle of a jack, or the handle of a tire-changing, or the handle of a garden tool.
